(19) United States
(12) Patent Application Publication
(10) Pub. No.: US 2018/0285940 A1
(43) Pub. Date: Oct. 4, 2018

(54) WEB ADVERTISEMENT PLACEMENT

(71) Applicant: Google Inc., Mountain View, CA (US)

(72) Inventors: Stefano CAZZULANI, Munich (DE); Wieland HOLFELDER, Graefelfing (DE)

(21) Appl. No.: 14/340,490

(22) Filed: Jul. 24, 2014

(51) Int. Cl. G06Q 30/02; G06F 17/22

(52) U.S. Cl. CPC G06Q 30/0277; G06F 17/2247

(57) ABSTRACT

Techniques for web advertisement placement are provided. An example method includes receiving mark-up language defining web content for display in a web application, parsing the mark-up language to identify particular mark-up language representing advertisement content that is to be rendered for display within the web content, determining one or more characteristics of the advertisement content based on the particular mark-up language, and based on the one or more determined characteristics, rendering the advertisement content for display in a region outside the web content when the web content is displayed in the web application.

### BACKGROUND

The present disclosure relates generally to web content and particularly to advertisements related to such web content. Webpages often include advertisements (e.g., image or video advertisements) that can be displayed within content of the webpages. When viewing a webpage that includes one or more advertisements on a device, the advertisements may be displayed at different locations within the webpage.

### SUMMARY

The disclosed subject matter relates to web advertisement placement.

In some innovative implementations, the disclosed subject matter can be embodied in a method. The method comprises receiving mark-up language defining web content for display in a web application, parsing the mark-up language to identify particular mark-up language representing advertisement content that is to be rendered for display within the web content, determining one or more characteristics of the advertisement content based on the particular mark-up language and based on the one or more determined characteristics, rendering the advertisement content for display in a region outside the web content when the web content is displayed in the web application.

In some innovative implementations, the disclosed subject matter can be embodied in a machine-readable medium. The machine-readable medium includes instructions, which when executed by a processor, cause the processor to perform operations comprising receiving mark-up language defining web content for display in a web application, parsing the mark-up language to identify particular mark-up language representing advertisement content that is to be rendered for display within the web content, determining one or more characteristics of the advertisement content based on the particular mark-up language, and based on the one or more determined characteristics, providing the advertisement content for display in a region outside the web content when the web content is displayed in the web application.

In some innovative implementations, the disclosed subject matter can be embodied in a system. The system comprises a memory comprising instructions and a processor configured to execute the instructions to receive mark-up language defining web content for display, parse the mark-up language to identify particular mark-up language representing one or more of first advertisement content or second advertisement content that is to be rendered for display within the web content, where the first advertisement content is associated with one or more first interactive elements and the second advertisement content is associated with one or more second interactive elements, replace the first interactive elements and second interactive elements with one or more common interactive elements, determine one or more characteristics of the one or more of the first advertisement content or the second advertisement content based on the particular mark-up language and based on the one or more determined characteristics, render the one or more of first advertisement content or second advertisement content for display with the common interactive elements.

In some innovative implementations, the disclosed subject matter can be embodied in a method. The method comprises receiving advertisement content for display within web content at a web application, embedding in mark-up language defining the web content particular mark-up language representing the advertisement content, where the particular mark-up language indicates one or more characteristics of the advertisement content and one or more instructions to render the advertisement content for display in a region outside the web content when the web content is displayed at the web application, and providing the mark-up language embedded with the particular mark-up language to the web application for display.

In some innovative implementations, the disclosed subject matter can be embodied in a method. The method comprises receiving mark-up language defining web content for display in a web application, automatically detecting from the mark-up language particular mark-up language representing advertisement content that is to be rendered for display within the web content, determining one or more of characteristics of the advertisement content or one or more instructions to render the advertisement content based on the particular mark-up language, and based on one or more of the determined characteristics or instructions, rendering the advertisement content for display in a region outside the web content when the web content is displayed in the web application.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the accompanying figures summarized below.

FIG. 1 is a diagram of an example device and network environment suitable for practicing some implementations of the subject technology.

FIGS. 2-5 illustrate example display of advertisements in accordance with the subject technology using the example device of FIG. 1

FIG. 6A-6C are example processes for practicing implementations of the subject technology using the example device of FIG. 1.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The subject technology is not limited to the specific details set forth herein and may be practiced without these specific details.

Webpages often include advertisements (e.g., image or video advertisements) that can be displayed within content of the webpages. When viewing a webpage that includes one or more advertisements on a device, the advertisements may be displayed at different locations within the webpage. When a user scrolls the web page, an advertisement may scroll together with content. As a result, the user may miss viewing the advertisement or may not remember the location of the advertisement to view the advertisement again. Thus, the user may not be able to sufficiently interact with the advertisement reducing the advertisement's effectiveness. Furthermore, in some cases, the advertisement may be displayed with characteristics (e.g., dimensions) that may not be optimal for a particular display screen size. This may degrade the user's viewing experience.

The disclosed implementations can receive mark-up language defining web content for display in a web application and parse the mark-up language to identify particular mark-up language representing advertisement content that is to be rendered for display within the web content. One or more characteristics (e.g., dimensions, file format, ad network association, etc.) of the advertisement content can be automatically determined based on the particular mark-up language. Based on the determined characteristics, the advertisement content can be rendered for display in a region outside the web content when the web content is displayed in the web application. In this way, because the advertisement content is rendered in a region outside the web content, visibility of the advertisement may be increased and can improve user experience.

In some implementations, as the web content is scrolled in the web application, advertisement content that is associated with a currently displayed portion of web content may be locked for display in the region outside the web content. Thus, the user may be able to better interact with the advertisement increasing the advertisement's effectiveness. Additionally, because the disclosed implementations render the advertisement content for display in the region based on the determined characteristics (e.g., dimensions) the advertisement content may be displayed in the region having characteristics that may be optimal for a particular display screen size. Furthermore, in some implementations, the advertisement content may be displayed in the region with common user interface elements (e.g., buttons) that replace any original (e.g., custom) interactive elements associated with the advertisements. In this way, the user is able to interact with the advertisements via common user elements that can remain consistent across different advertisement content. This can enhance user experience.

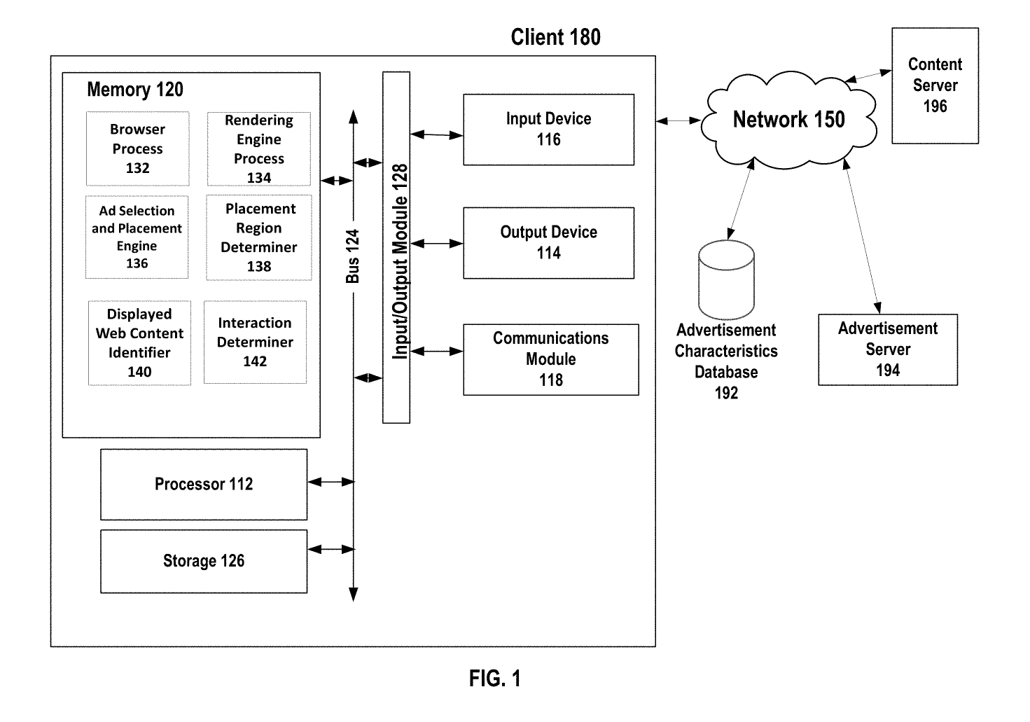

FIG. 1 is a diagram illustrating example architecture for web advertisement placement according to some implementations of the subject technology. Client 180 includes processor 112, memory 120, storage 126, bus 124, input/output module 128, input device 116, output device 114 and communications module 118. Memory 120 includes browser process 132, rendering engine process 134, advertisement (“ad”) detection engine 136, ad selection and placement engine 138, displayed web content identifier 140 and interaction determiner 142. Client 180 may additionally include an output device (e.g., touch screen display, non-touch screen display), input device (e.g., a keyboard, touchscreen, or mouse) to receive user input. In some implementations, client 180 includes one or more modules for facilitating user interaction with via a browser.

Content server 196 may be implemented as a single machine with a single processor, a multi-processor machine, or a server farm including multiple machines with multiple processors. Communication module 118 can enable client 180 to send and receive data over network 150 to content server 196, ad characteristics database 192 and advertisement server 194. In some implementations, content server 196 can include data including but not limited to video, audio, text, images or any combination thereof. The data stored at content server 196 may be provided for display in web pages, web applications or any other web content areas. For example, a video stored at content server 196 may be streamed to a web page (or web application) for display to a user via client 180. In another example, audio stored at content server 196 may be streamed to a web page (or web application) for playback to a user via client 180.

In some implementations content server 196 can be associated with an advertisement server 194 that includes advertisement content (e.g., images, video, audio or any combination thereof) and may send and receive data over network 150 to advertisement server 194. In some implementations, advertisement server 194 may store advertisement content provided by entities seeking to advertise products, services or content or other items that may be advertised. In some implementations, advertisement server 194 may also include user generated content (e.g., posts, videos, images etc.). In some implementations, advertisement server 194 may provide advertisement content to content server 196. Content server 196 may include the advertisement content within web content that is provided for display to client 180. In some implementations, ad server 194 may provide a markup language code (e.g., Hyper Text Markup Language (HTML)) that provides a reference to the advertisement content. Content server 196 may then embed the markup language code within the markup language defining the web content that is to be provided for display to the client. In some implementations, the markup language that is provided by ad server 194 may be associated with a particular advertising network or advertising entity (e.g., company). The advertising entity may have certain preferences on display format of an advertisement, dimensions of an advertisement, user interface elements (or controls) associated with and advertisement and any other ad characteristics. In some implementations, these preferences may be specified in the markup language code provided by ad server 194 to content server 196. In some implementations, these preferences may be stored (e.g., stored in a database table) by content server 196 at ad characteristics database 192. In some implementations, the preferences may be updated by ad server 194 or content sever 196 as updated preferences may be received from advertising entities.

In some implementations, content server 196 may receive advertisement content for display within web content at a web application at client 180. Content server 196 may embed in mark-up language defining the web content particular mark-up language representing the advertisement content, where the particular mark-up language indicates one or more characteristics of the advertisement content and one or more instructions to render the advertisement content for display in a region outside the web content when the web content is displayed at the web application, and provide the mark-up language embedded with the particular mark-up language to the web application for display at client 180. In some implementations, content server 196 may identify a first portion of the web content that is currently being displayed at client 180, determine first advertisement content associated with the first portion of the web content, and provide for display, in the region, the first advertisement content associated with the first portion of the web content. In some implementations, content server 196 may determine whether a second portion of the web content is currently being displayed. When the second portion of the web content is currently being displayed, content server 196 may determine second advertisement content associated with the second portion of the web content, and provide one or more instructions to replace, in the region, the displayed first advertisement content with the second advertisement content.

It is to be appreciated that components included in client 180 may also be implemented at a server (e.g., content server 196 or ad server 194). For example, content server 196 may include, but is not limited to, one or more of ad detection engine 136, ad selection and placement engine 138, displayed web content identifier 140 and interaction determiner 142. Content server 196, including one or more of these components, may communicate with browser process 132 and rendering engine process 134 at client 180.

In some implementations, client 180, content server 196, ad characteristics database 192, ad server 194 can communicate with each other via a network 150. Network 150 may include the Internet, an intranet, a local area network, a wide area network, a wired network, a wireless network, or a virtual private network (VPN). While only one client 180, content server 196, ad characteristics database 192, ad server 194 are illustrated, the subject technology may be implemented in conjunction with any number of clients 180, content servers 196, ad characteristics databases 192, ad servers 194. In some non-limiting implementations, a single computing device may implement the functions of content server 196, ad characteristics database 192 and ad server 194 and other components illustrated in FIG. 1.

Client 180 can be a laptop computer, a desktop computer, a mobile phone, a personal digital assistant (PDA), a tablet computer, a netbook, a television with one or more processors embedded therein or coupled thereto, a physical machine, or a virtual machine. Client 180 may each include one or more of a keyboard, a mouse, a display, or a touch screen. Client 180 can include a browser configured to display webpages. For example, the browser can display a webpage including web and ad content from content server 196 and ad server 194. Client 180 may include special-purpose applications (e.g., mobile phone, web applications or tablet computer applications) for accessing, viewing and interacting with web and ad content from content server 194 and ad server 196.

As discussed above, memory 120 of client 180 can include browser process 132, rendering engine process 134, ad detection engine 136, ad selection and placement engine 138, displayed web content identifier 140 and interaction determiner 142.

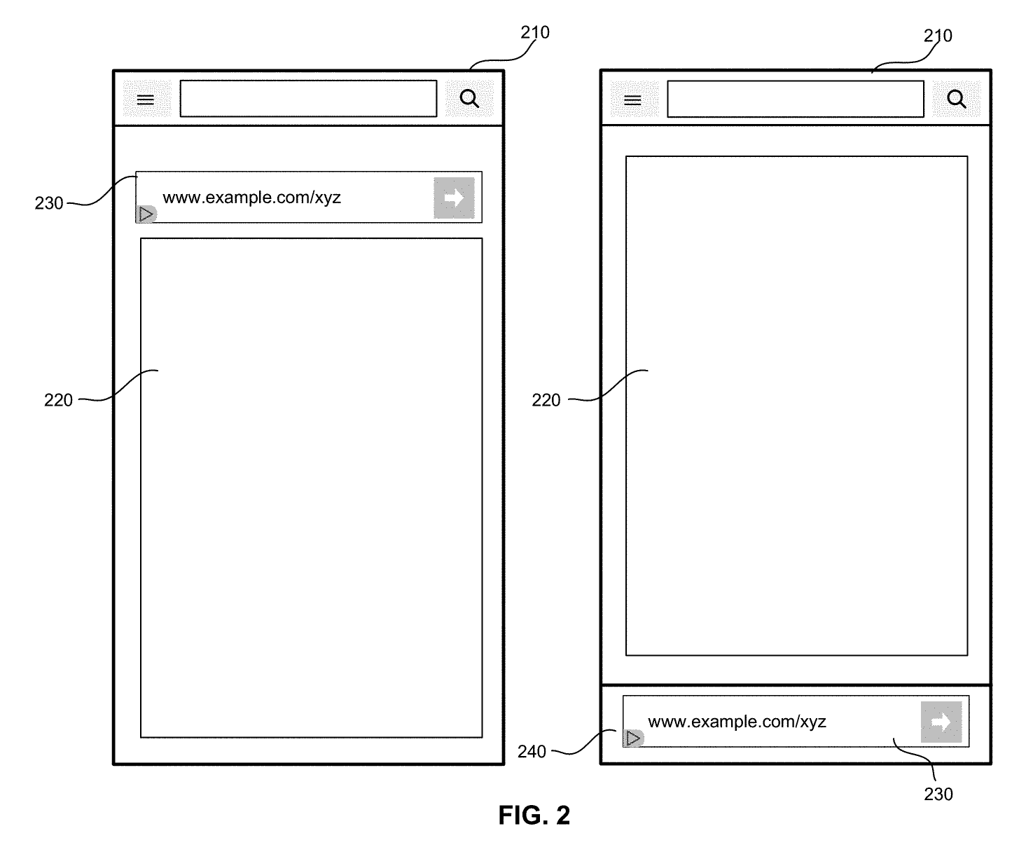

Referring to FIG. 1 and FIG. 2, in some implementations, browser process 132 of web browser 210 (or web application 130) may receive mark-up language defining web content for display in the web browser 210. Ad detection engine 136 may parse the mark-up language to automatically identify or automatically detect particular mark-up language (or code) representing advertisement content (e.g., advertisement content 230) that is to be rendered for display within the web content for display in the web browser 210. Advertisement content may include links, banner ads, images, video or any combination thereof and the figures discussed herein are not intended to limit the disclosed implementations. Ad detection engine 136 may determine one or more characteristics (e.g., file type, dimensions, format, placement location, etc.) of the advertisement content 230 based on the particular mark-up language. Rendering engine process 134 may, based on the one or more determined characteristics, render the advertisement content for display in region 240 outside the web content when the web content is displayed in web browser 210 (or web application 130).

In some implementations, the identification of the particular mark-up language by ad detection engine 136 can be based on one or more of: mark-up language constructs associated with one or more particular digital advertising networks, resources retrieved from third-party domains or characteristics of advertisements associated with the particular digital advertising networks. In some implementations, ad detection engine 136 may identify a particular identifier (e.g., affiliate identifier) embedded in the particular markup language that is known to be associated with advertisements or advertising companies. This association may be determined based on association data that may be stored at ad characteristics database 192. Based on this determination, ad detection engine 136 may identify particular mark-up language (or code) representing advertisement content (e.g., advertisement content 230) that is to be rendered for display within the web content for display in the web browser 210.

In some implementations, ad detection engine 136 may identify a particular markup language structure (e.g., formatting, location placement instructions for content, etc.) that is known to be associated with advertisements. This association may be determined based on association data that may be stored at ad characteristics database 192. Based on this determination, ad detection engine 136 may identify particular mark-up language (or code) representing advertisement content (e.g., advertisement content 230) that is to be rendered for display within the web content for display in the web browser 210.

In some implementations, ad detection engine 136 may identify one or more resources from third-party domains (or third-party domains themselves) that are referenced in the particular markup language. These third-party resources and third party domains may be known to be associated with advertisements. This association may be determined based on association data that may be stored at ad characteristics database 192. Based on this identification, ad detection engine 136 may identify particular mark-up language (or code) representing advertisement content (e.g., advertisement content 230) that is to be rendered for display within the web content for display in the web browser 210. Such markup language may include, but is not limited to “div” and frame constructs that may have been previously identified and stored in ad characteristics database 192 by ad detection engine 136. In some implementations, ad detection engine 136 may perform operations including those related to identification of ad content in advance of the web content being displayed at web browser 210. In addition, ad detection engine 136 may load and process resources needed to display ads in advance of the web content being displayed at web browser 210. The web content itself may be displayed faster in web browser 210 because ad content need not be processed again by browser process 132. In this way, the disclosed implementations can allow optimized loading and display of web content.

In some implementations, ad detection engine 136 may identify one or more characteristics of ad content (e.g., file type, pixel dimensions, format, etc.) that are referenced in the particular markup language. These characteristics may be known to be associated with advertisements. This association may be determined based on association data that may be stored at ad characteristics database 192. Based on this identification, ad detection engine 136 may identify particular mark-up language (or code) representing advertisement content (e.g., advertisement content 230) that is to be rendered for display within the web content for display in the web browser 210.

In some implementations, ad detection engine 136 may determine whether the user has opted in (e.g., via a selection at browser 210) to view ads that are displayed in accordance with the disclosed embodiments. In some implementations, an advertiser (or publisher) may opt in to allowing display of ads from the advertiser, in accordance with the disclosed embodiments, by including a mark-up language header (e.g., HTML header or Hyper Text Transfer Protocol (HTTP) header.) with ads provided by the advertiser. In some implementations, an ad network may identify ads from the ad network by including a particular attribute in mark-up language associated with an ad provided by the ad network. An ad network or advertiser may be able to mark a particular portion of mark-up language as a portion that references an ad. In some implementations, ad detection engine 136 may detect the particular attribute to conveniently identify ads in markup language defining web content.

Referring to FIG. 1 and FIG. 2, in some implementations, displayed web content identifier 140 can identify a first portion 220 of the web content that is currently being displayed. Ad detection engine 136 may determine first advertisement content 230 associated with the first portion of the web content, and rendering engine process 134 can display, in region 240, the first advertisement content associated with the first portion of the web content. In some implementations, the first advertisement content 230 may be locked for display in region 240. In some implementations, region 240 can be a region that is outside and separate from the displayed web content. Region 240 may be located separate and outside web browser 210. In some implementations, even when the web content that is currently being displayed is scrolled, region 240 may continue to display the first advertisement content while the identified first portion 220 of the web content is currently being displayed. In some implementations, region 240 may be associated with an independent process that is separate from browser process 132 and rendering engine process 134. In some implementations, region 240 may be located within web browser 210. It is to be appreciated that region 240 need not be located below web browser 210 and may be located in any other area above web browser 210 and at any side (e.g., left, right, corner, etc.) region relative to web browser 210. Furthermore, region 240 may be hidden from display or minimized upon receiving a particular interaction (e.g., user touch gesture) at region 240. Region 240 may be made to reappear from hidden view upon receiving another interaction. Ad content displayed in region 240 may include different types of ad content including, pop-ups, banners, icons or full-screen ad content. These examples are illustrative and are not intended to limit the disclosed implementations.

In this way, because first advertisement content 230 is rendered in region 240 outside the web content, visibility of first advertisement content 230 may be increased and can improve user experience. A user may also be able to better interact with the advertisement increasing the advertisement's effectiveness. Additionally, because the disclosed implementations can render the first advertisement content 230 for display in region 240 based on the determined characteristics (e.g., dimensions), first advertisement content 230 may be displayed in region 240 having characteristics that may be optimal for a particular display screen size. Furthermore, in some implementations, first advertisement content 230 may be displayed in region 240 with common user interface elements (e.g., buttons) that replace any original (e.g., custom) interactive elements associated with the first advertisement content 230. In this way, the user is able to interact with the advertisements via common user elements that can remain consistent across different advertisement content. This can enhance user experience.

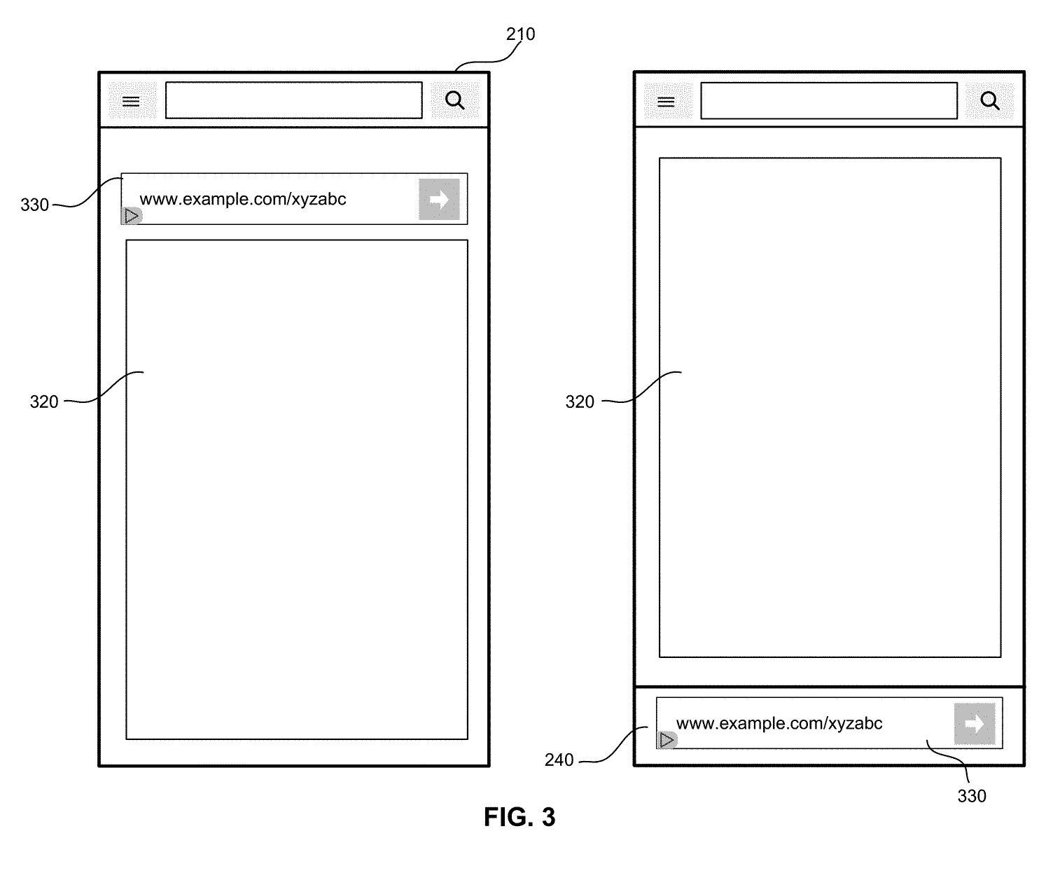

Referring to FIG. 1 and FIG. 3, in some implementations, displayed web content identifier 140 can determine whether a second portion 320 of the web content is currently being displayed. In some implementations, the determination of whether second portion 320 of the web content is currently being displayed is performed by displayed web content identifier 140 when the web content is scrolled in web browser 210. The determination may be performed when an indication that the web content is scrolled in web browser 210 is received from interaction determiner 142. When the second portion 320 of the web content is currently being displayed, ad detection engine 136 may determine second advertisement content 330 associated with the second portion 320 of the web content and rendering engine process 134 can replace, in the region 240, the displayed first advertisement content 230 with the second advertisement content 330. In this way, as web content is scrolled in web browser 210, region 240 automatically updates to replace displayed first advertisement content 230 with second advertisement content 330.

In some implementations, the second advertisement content 330 may be locked for display in region 240 while the second portion 320 of the web content is being displayed. In some implementations, as the web content is again scrolled in web browser 210 to return to displaying the second portion 320, region 240 automatically updates to replace displayed second advertisement content 330 with first advertisement content 230. It is to be appreciated that in some implementations, second advertisement content 330 and the first advertisement content 230 are not displayed within the web content where they were originally provided for display by content server 196, but are instead displayed in region 240 in accordance with the disclosed implementations. In some implementations, first advertisement content 230 and second advertisement content 330 may be stored at client 180 for future display in region 240. In other words, and for example, first advertisement content 230 and second advertisement content 330 may be deferred for display to a time after they were originally intended to be displayed along with their respective displayed portions of web content.

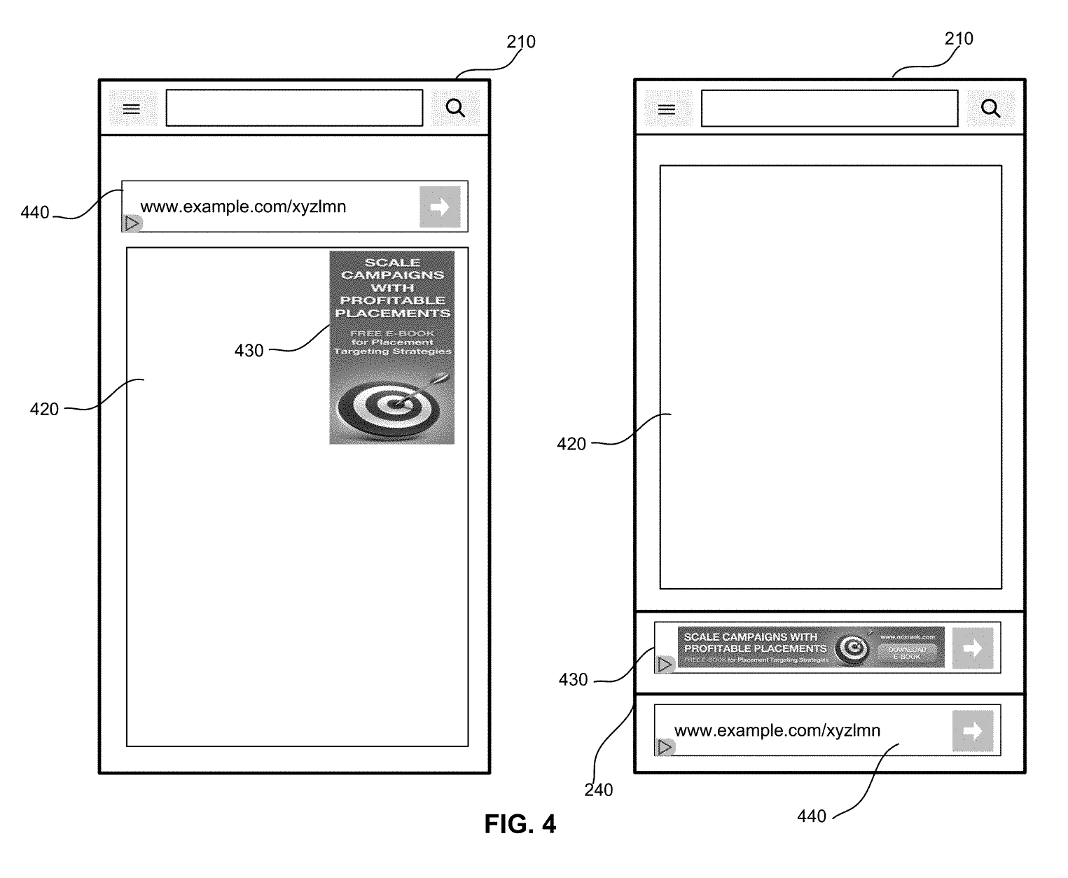

Referring to FIG. 1 and FIG. 4, in some implementations, displayed web content identifier 140 can determine whether a third portion 420 of the web content is currently being displayed. When the third portion of the web content 420 is currently being displayed, ad detection engine 136 may determine third advertisement content 430 and fourth advertisement content 440 associated with the third portion 420 of the web content. Rendering engine process 134 may replace, in the region 240, the displayed first advertisement content 230 with one or more of the third advertisement content 430 or the fourth advertisement content 440, based on respective characteristics of the third and the fourth advertisement content. In some implementations, the determination of whether third advertisement content 430 or the fourth advertisement content 440 is to be displayed in region 240 may be performed by ad selection and placement engine 138.

In some implementations, ad selection and placement engine 138 may select one of third advertisement content 430 or the fourth advertisement content 440 based on their respective dimensions relative to a dimension of region 240. For example, if dimensions of fourth advertisement content 440 are significantly larger than those of third advertisement content 430, ad selection and placement engine 138 may, for example, select third advertisement content 430 for display in region 240. In some implementations, both third advertisement content 430 and the fourth advertisement content 440 can be selected for display by ad selection and placement engine 138 in the region 240. In this scenario, rendering engine 134 may display both third advertisement content 430 and the fourth advertisement content 440 in a stacked manner or one above (or adjacent) another.

In some implementations, region 240 to be automatically resized (or re-dimensioned) by rendering engine process 134 because such a stacked display may need different dimensions. In some implementations, rendering engine process 134 may display both third advertisement content 430 and the fourth advertisement content 440 upon one or more of: permitting scrolling within the web content of other advertisement content that is to be rendered for display (so that content for which scrolling has been permitted need not be displayed in re-dimensioned region 240), relocating advertisement content that may be currently displayed within the web content, or relocating advertisement content that can be currently displayed in region 240. In this way, rendering engine process 134 may create more space that may be needed to display re-dimensioned region 240. In some implementations, rendering engine process 134 may move all visible ads to for inclusion and display in region 240. In some implementations, when multiple ads are to be displayed in region 240, they may be displayed in rotation where a displayed advertisement in region 240 is replaced by another displayed advertisement after a predetermined interval of time or as a user scrolls content displayed in browser 210.

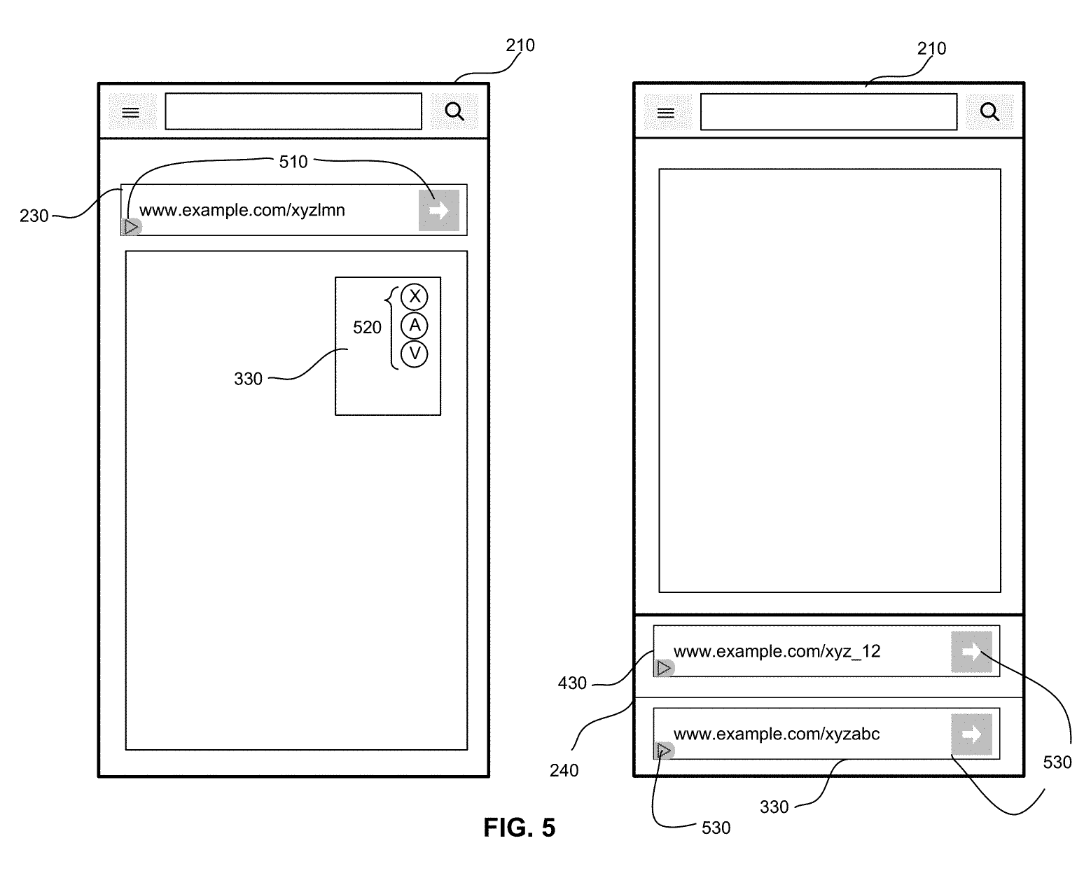

Referring to FIG. 1 and FIG. 5, browser process 132 of web browser 210 (or web application 130) may receive mark-up language defining web content for display in the web browser 210. Ad detection engine 136 may parse the mark-up language to identify particular mark-up language representing one or more of first advertisement content 230 or second advertisement content 330 that is to be rendered for display within the web content. As shown in FIG. 5, the first advertisement content 230 is associated with one or more first interactive elements 510 and the second advertisement content 330 can associated with one or more second interactive elements 520. First interactive elements 510 may have visual design and functions that are customized or specific to first advertisement content 230. Second interactive elements 520 may have visual design and functions different from first interactive elements 510 and customized and specific to second advertisement content 330.

In some implementations, rendering engine process 134 may replace the first interactive elements 510 and second interactive elements 520 with one or more common interactive elements 530. Common interactive elements 530 may have visual style and functions different from first interactive elements 510 and second interactive elements 520. In some implementations, ad detection engine 136 may automatically detect functions (e.g., hide ad, expand ad, report ad, mute ad, etc.) associated with first interactive elements 510 and second interactive elements 520 and may instruct rendering engine 134 to generate for display common interactive elements 530 that may have a visual style different from first interactive elements 510 and second interactive elements 520 but include similar functions provided by the first interactive elements 510 and the second interactive elements 520. Ad detection engine 136 may determine one or more characteristics of the one or more of the first advertisement content 230 or the second advertisement content 330 based on the particular mark-up language and based on the one or more determined characteristics, render the one or more of first advertisement content or second advertisement content for display with the common interactive elements 530.

In some implementations, the one or more of first advertisement content or second advertisement content can be rendered for display in region 204 outside the web content when the web content is displayed in a web browser 132 (or web application 130). In some implementations, ad detection engine 136 may identify a first portion 220 of the web content that is currently being displayed, determine whether the first advertisement content 230 associated or the second advertisement content 330 is associated with the first portion 220 of the web content and display, in the region 240, the first advertisement content 230 or the second advertisement content 330 based on the determined association. In some implementations, characteristics (e.g., visual style, dimensions, functions, etc.) of the common interactive elements 530 are independent of characteristics of the first interactive elements 510 and the second interactive elements 520.

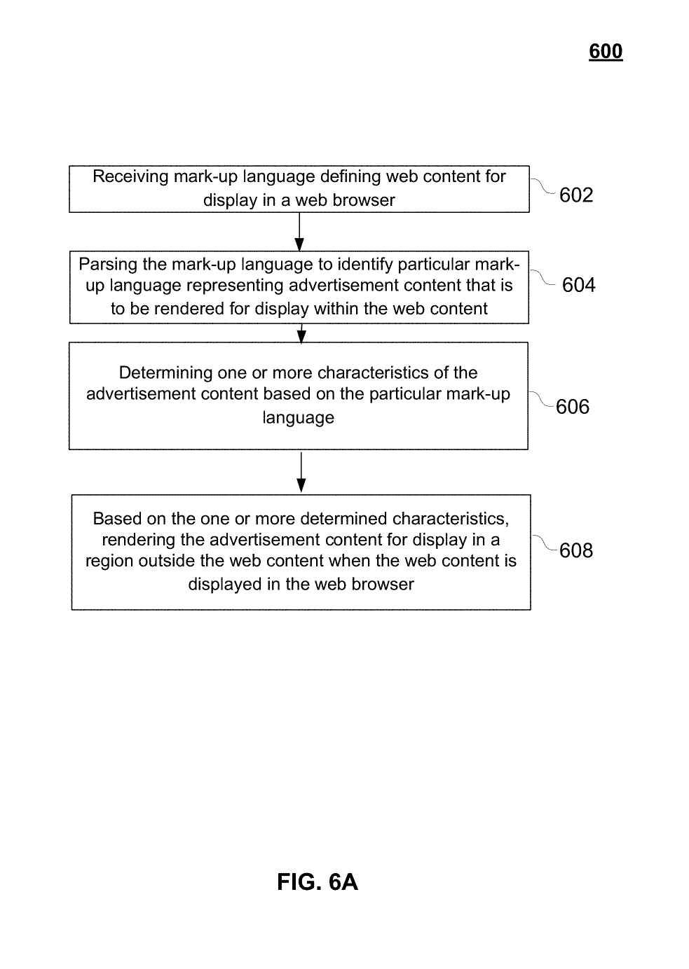

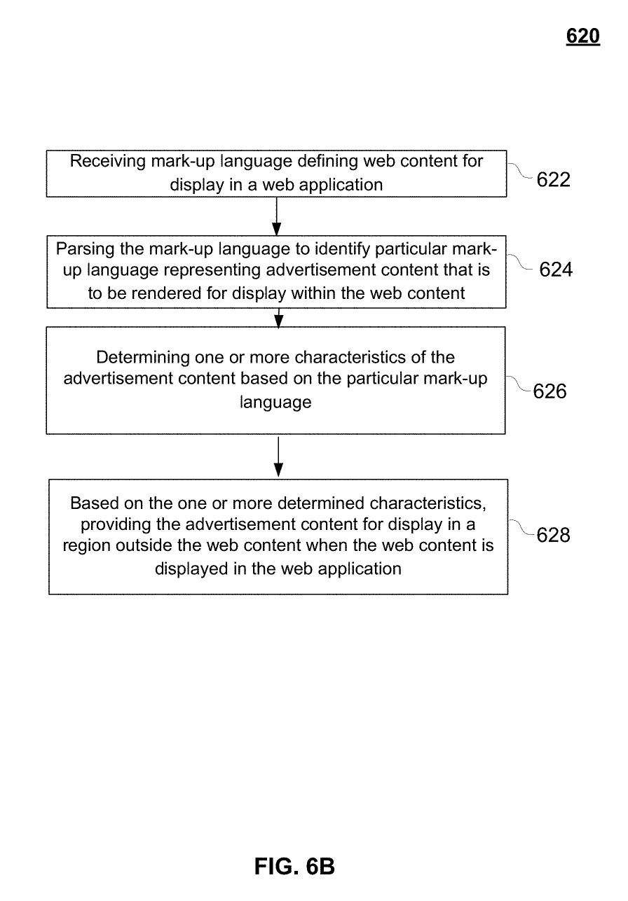

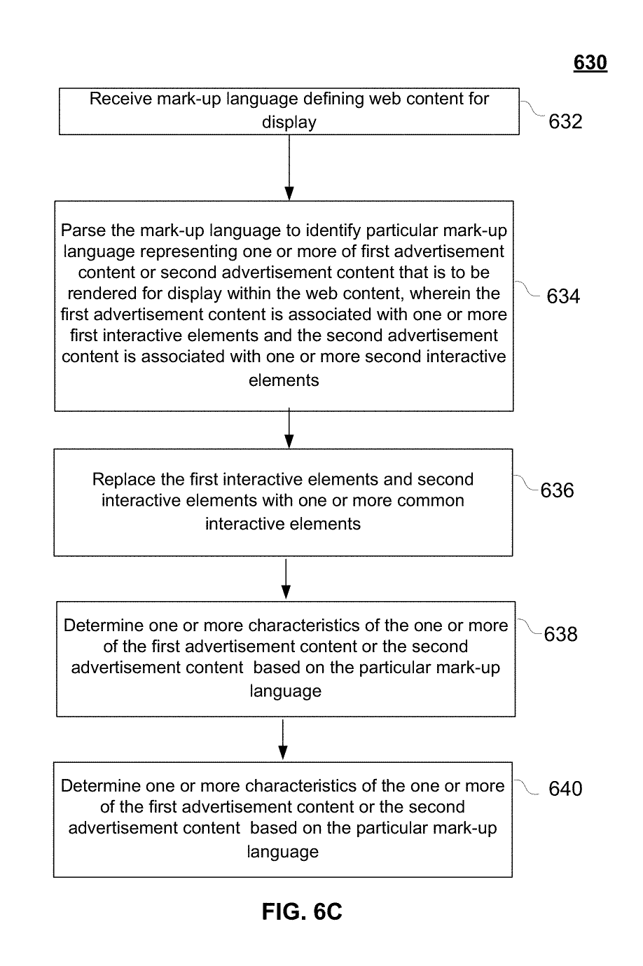

FIG. 6A is an example process 600 for practicing implementations of the subject technology using the example architecture of FIG. 1. Although FIG. 6A is described with reference to the elements of FIG. 1, the process of FIG. 6A is not limited to such and can be applied within other systems.

Process 600 begins with receiving mark-up language defining web content for display in a web browser (block 602). For example, browser process 132 of web browser 210 (or web application 130) may receive mark-up language defining web content for display in the web browser 210.

Process 600 proceeds by parsing the mark-up language to identify particular mark-up language representing advertisement content that is to be rendered for display within the web content (block 604). For example, ad detection engine 136 may parse the mark-up language to identify particular mark-up language (or code) representing advertisement content (e.g., advertisement content 230) that is to be rendered for display within the web content for display in the web browser 210.

One or more characteristics of the advertisement content based on the particular mark-up language may be determined (block 606). For example, ad detection engine 136 may determine one or more characteristics (e.g., file type, dimensions, format, placement location, etc.) of the advertisement content 230 based on the particular mark-up language.

Based on the one or more determined characteristics, the advertisement content may be rendered for display in a region outside the web content when the web content is displayed in the web browser (block 608). As an example, rendering engine process 134 may, based on the one or more determined characteristics, render the advertisement content for display in region 240 outside the web content when the web content is displayed in web browser 210 (or web application 130).

FIG. 6B is an example process 600 for practicing implementations of the subject technology using the example architecture of FIG. 1. Although FIG. 6B is described with reference to the elements of FIG. 1, the process of FIG. 6B is not limited to such and can be applied within other systems.

Process 620 begins with receiving mark-up language defining web content for display in a web browser (block 622). For example, web application 130 may receive mark-up language defining web content for display in web application 130.

Process 620 proceeds by parsing the mark-up language to identify particular mark-up language representing advertisement content that is to be rendered for display within the web content (block 624). For example, ad detection engine 136 may parse the mark-up language to identify particular mark-up language (or code) representing advertisement content (e.g., advertisement content 230) that is to be rendered for display within the web content for display in the web application 130.

One or more characteristics of the advertisement content based on the particular mark-up language may be determined (block 626). For example, ad detection engine 136 may determine one or more characteristics (e.g., file type, dimensions, format, placement location, etc.) of the advertisement content 230 based on the particular mark-up language.

Based on the one or more determined characteristics, the advertisement content can be provided for display in a region outside the web content when the web content is displayed in the web application (block 628). As an example, rendering engine process 134 may, based on the one or more determined characteristics, can provide the advertisement content for display in region 240 outside the web content when the web content is displayed in web application 130. It is to be appreciated that process 620 may also be performed at content server 196 or ad server 194.

FIG. 6C is an example process 630 for practicing implementations of the subject technology using the example architecture of FIG. 1. Although FIG. 6C is described with reference to the elements of FIG. 1, the process of FIG. 6C is not limited to such and can be applied within other systems.

Process 630 begins with receiving mark-up language defining web content for display in a web browser (block 632). For example, browser process 132 of web browser 210 (or web application 130) may receive mark-up language defining web content for display in the web browser 210.

Process 630 proceeds by parsing the mark-up language to identify particular mark-up language representing one or more of first advertisement content or second advertisement content that is to be rendered for display within the web content (block 634). The first advertisement content can be associated with one or more first interactive elements and the second advertisement content can be associated with one or more second interactive elements. As shown in FIG. 5, the first advertisement content 230 is associated with one or more first interactive elements 510 and the second advertisement content 330 can associated with one or more second interactive elements 520. First interactive elements 510 may have visual design and functions that are customized or specific to first advertisement content 230. Second interactive elements 520 may have visual design and functions different from first interactive elements 510 and customized and specific to second advertisement content 330.

The first interactive elements and second interactive elements may be replaced with one or more common interactive elements (block 636). For example, rendering engine process 134 may replace the first interactive elements 510 and second interactive elements 520 with one or more common interactive elements 530. Common interactive elements 530 may have visual style and functions different from first interactive elements 510 and second interactive elements 520.

One one or more characteristics of the one or more of the first advertisement content or the second advertisement content based on the particular mark-up language may be determined (block 638) and based on the one or more determined characteristics, the one or more of first advertisement content or second advertisement content may be rendered for display with the common interactive elements (block 640). For example, ad detection engine 136 may determine one or more characteristics of the one or more of the first advertisement content 230 or the second advertisement content 330 based on the particular mark-up language and based on the one or more determined characteristics, render the one or more of first advertisement content or second advertisement content for display with the common interactive elements 530.

Returning to FIG. 1, in certain aspects, client 180 may be implemented using hardware or a combination of software and hardware, either in a dedicated server, or integrated into another entity, or distributed across multiple entities.

Client 180 includes a bus 124 or other communication mechanism for communicating information, and processor 112 coupled with bus 124 for processing information. Processor 112 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Client 180 can include, in addition to hardware, code that creates an execution environment for the computer program in question, e.g., code that constitutes processor firmware, a protocol stack, a database management system, an operating system, or a combination of one or more of them stored in memory 120. Memory 120 may include Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 124 for storing information and instructions to be executed by processor 112. The processor 112 and the memory 120 can be supplemented by, or incorporated in, special purpose logic circuitry.

The instructions may be stored in the memory 120 and implemented in one or more computer program products, i.e., one or more modules of computer program instructions encoded on a computer readable medium for execution by, or to control the operation of, the client 180, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 120 may also be used for storing temporary variable or other intermediate information during execution of instructions to be executed by processor 112.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output

Client 180 further includes a data storage device 126 such as a magnetic disk or optical disk, coupled to bus 124 for storing information and instructions. Client 180 may be coupled via input/output module 128 to various devices. The input/output module 128 can be any input/output module. Example input/output modules 128 include data ports such as USB ports. The input/output module 128 is configured to connect to a communications module 118. Example communications modules 118 (e.g., communications module 118 and 238) include networking interface cards, such as Ethernet cards and modems. In certain aspects, the input/output module 128 is configured to connect to a plurality of devices, such as an input device 116 and/or an output device 114. Example input devices 114 include a keyboard and a pointing device, e.g., a mouse or a trackball, by which a user can provide input to the client 180. Other kinds of input devices 114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 116 include display devices, such as a LED (light emitting diode), CRT (cathode ray tube), or LCD (liquid crystal display) screen, for displaying information to the user.

According to one aspect of the present disclosure, client 180 can be implemented using a client 180 in response to processor 112 executing one or more sequences of one or more instructions contained in memory 120. Such instructions may be read into memory 120 from another machine-readable medium, such as data storage device 126. Execution of the sequences of instructions contained in main memory 120 causes processor 112 to perform the process blocks described herein. One or more processors in a multi-processing arrangement may also be employed to execute the sequences of instructions contained in memory 120. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 170) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Client 180 can be, for example, and without limitation, a desktop computer, laptop computer, or tablet computer. Client 180 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 112 for execution. Such a medium may take many forms, including, but not limited to, non-volatile media and volatile media. Non-volatile media include, for example, optical disks, magnetic disks, or flash memory, such as data storage device 126. Volatile media include dynamic memory, such as memory 120. Transmission media include coaxial cables, copper wire, and fiber optics, including the wires that comprise bus 124. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate aspects can also be implemented in combination in a single aspect. Conversely, various features that are described in the context of a single aspects can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method comprising:
receiving mark-up language defining web content for display in a first region of a web application;
parsing the mark-up language;
identifying, in the parsed mark-up language, particular mark-up language representing first message content and second message content to be rendered for display within the web content in the first region based on characteristics referenced in the particular mark-up language associated with message content, wherein the first message content comprises first user input elements and the second message content comprises second user input elements;
replacing at least one of the first user input elements or the second user input elements with respective elements that have a predefined common format for consistent user interaction across message content;
determining one or more display characteristics of the first message content and the second message content based on the particular mark-up language; and
based on the replacing and on the one or more determined display characteristics, rendering automatically without user interaction the first message content and the second message content for simultaneous display in a second region separately visible from the web content in the first region when the web content is displayed in the web application.

2. The computer implemented method of claim 1, further comprising:
identifying a first portion of the web content that is currently being displayed;
determining the first message content associated with the first portion of the web content; and
displaying, in the second region, the first message content associated with the first portion of the web content.

3. The computer implemented method of claim 2, further comprising:
determining whether a second portion of the web content is currently being displayed;
when the second portion of the web content is currently being displayed, determining the second message content associated with the second portion of the web content; and
replacing, in the second region, the displayed first message content with the second message content.

4. The computer implemented method of claim 3, wherein the determining whether the second portion of the web content is currently being displayed is performed when the web content is scrolled in the web application.

5. The computer implemented method of claim 1, wherein the identification of the particular mark-up language is based on one or more of: mark-up language constructs associated with one or more particular digital messaging networks, resources retrieved from third-party domains or characteristics of messages associated with the particular digital messaging networks.

6. The computer implemented method of claim 2, further comprising:
determining whether a second portion of the web content is currently being displayed;
when the second portion of the web content is currently being displayed, determining second and third message content associated with the second portion of the web content; and
replacing, in the second region, the displayed first message content with one or more of the second or the third message content, based on respective characteristics of the second and the third message content.

7. (canceled)

8. A non-transitory machine-readable medium comprising instructions stored therein, which when executed by a processor, causes the processor to perform operations comprising:
receiving mark-up language defining web content for display in a first region of a web application;
parsing the mark-up language;
identifying, in the parsed mark-up language, particular mark-up language representing first message content and second message content to be rendered for display within the web content in the first region based on characteristics referenced in the particular mark-up language associated with message content, wherein the first message content comprises first user input elements and the second message content comprises second user input elements;
replacing at least one of the first user input elements or the second user input elements with respective elements that have a predefined common format for consistent user interaction across message content;
determining one or more display characteristics of the first message content and the second message content based on the particular mark-up language; and
based on the replacing and on the one or more determined display characteristics, providing automatically without user interaction the first message content and the second message content for simultaneous display in a second region separately visible from the web content in the first region when the web content is displayed in the web application.

9. The non-transitory machine-readable medium of claim 8, further comprising:
identifying a first portion of the web content that is currently being displayed;
determining the first message content associated with the first portion of the web content; and
providing for display, in the second region, the first message content associated with the first portion of the web content.

10. The non-transitory machine-readable medium of claim 9, further comprising instructions stored therein, which when executed by the processor, causes the processor to perform operations comprising:
determining whether a second portion of the web content is currently being displayed;
when the second portion of the web content is currently being displayed, determining the second message content associated with the second portion of the web content; and
providing one or more instructions to replace automatically, in the second region, the displayed first message content with the second message content.

11. The non-transitory machine-readable medium of claim 10, wherein the determining whether the second portion of the web content is currently being displayed is performed when the web content is scrolled in the web application.

12. The non-transitory machine-readable medium of claim 8, wherein the identification of the particular mark-up language is based on one or more of: mark-up language constructs associated with one or more particular digital messaging networks, resources retrieved from third-party domains or characteristics of messages associated with the particular digital messaging networks.

13. The non-transitory machine-readable medium of claim 9, further comprising instructions stored therein, which when executed by the processor, causes the processor to perform operations comprising:
determining whether a second portion of the web content is currently being displayed;
when the second portion of the web content is currently being displayed, determining second and third message content associated with the second portion of the web content; and
providing one or more instructions to replace automatically, in the second region, the displayed first message content with one or more of the second or the third message content, based on respective characteristics of the second and the third message content.

14. (canceled)

15. A system comprising:
a memory comprising instructions; and
a processor configured to execute the instructions to:
receive mark-up language defining web content for display in a first region;
parse the mark-up language;
identify, in the parsed mark-up language, particular mark-up language representing one or more of first message content and second message content to be rendered for display within the web content in the first region based on characteristics referenced in the particular mark-up language associated with message content, wherein the first message content comprises first interactive elements and the second message content comprises second interactive elements;
replace automatically at least one of the first interactive elements or the second interactive elements with respective elements that have a predefined common format for consistent user interaction across message content;
determine one or more display characteristics of the one or more of the first message content and the second message content based on the particular mark-up language; and
based on the replacing and on the one or more determined display characteristics, render automatically without user interaction the first message content and the second message content for display.

16. The system of claim 15 wherein the one or more of first message content or second message content is rendered for display in a second region outside the web content of the first region when the web content is displayed in a web browser.

17. The system of claim 15, the processor further configured to execute the instructions to:
identify a first portion of the web content that is currently being displayed;
determine whether the first message content or the second message content is associated with the first portion of the web content; and
display automatically, in the first region, the first message content or the second message content based on the determined association.

19. The system of claim 16, wherein the identification of the particular mark-up language is based on one or more of: mark-up language constructs associated with one or more particular digital messaging networks, resources retrieved from third-party domains or characteristics of messages associated with the particular digital messaging networks.

20-22. (canceled)

23. A computer-implemented method comprising:
receiving mark-up language defining web content for display in a first region of a web application;
automatically detecting, from the mark-up language, particular mark-up language representing first message content and second message content to be rendered for display within the web content in the first region based on characteristics referenced in the particular mark-up language associated with message content, wherein the first message content comprises first user input elements and the second message content comprises second user input elements;
replacing at least one of the first user input elements or the second user input elements with respective elements that have a predefined common format for consistent user interaction across message content;
determining one or more of display characteristics of the first message content and the second message content; and
based on the replacing and the one or more of the determined display characteristics or instructions, rendering automatically without user interaction the first message content and the second message content for simultaneous display in a second region separately visible from the web content in the first region when the web content is displayed in the web application.

24. The computer implemented method of claim 23, further comprising:
identifying a first portion of the web content that is currently being displayed;
determining the first message content associated with the first portion of the web content; and
providing for display, in the region, the first message content associated with the first portion of the web content.

25. The computer implemented method of claim 24, further comprising:
determining whether a second portion of the web content is currently being displayed;
when the second portion of the web content is currently being displayed, determining the second message content associated with the second portion of the web content; and
providing one or more instructions to replace, in the region, the displayed first message content with the second message content.
